(19) United States
(12) Patent Application Publication
(10) Pub. No.: US 2025/0161962 A1
(43) Pub. Date: May 22, 2025

(54) Spraying Device

(71) Applicant: Hohe Tanne GmbH, Großbreitenbach (DE)

(72) Inventor: Thomas WEYRAUCH, Ilmenau (DE)

(21) Appl. No.: 18/950,582

(22) Filed: Nov. 18, 2024

(30) Foreign Application Priority Data
Nov. 17, 2023 (DE) 10 2023 132 072.6

(51) Int. Cl. B05B 1/26

(52) U.S. Cl. CPC B05B 1/267

(57) ABSTRACT

The invention relates to a spraying device (1) comprising a hollow cylindrical spray nozzle body (2) which has a connection molding (3) on an upper end face for connection to a fluid supply line and is closed on the opposite lower end face, a cylinder jacket of the spray nozzle body (2) having a plurality of fluid flow openings (4) arranged at the same height and distributed over a circumference of the spray nozzle body, wherein a number of baffle plates (5) corresponding to the number of fluid flow openings (4) are arranged on the spray nozzle body (2), wherein the baffle plates (5) are arranged distributed around the circumference of the spray nozzle body (2) and exactly one of the baffle plates (5) is assigned to each fluid flow opening (4), the baffle plates (5) being spaced apart from one another in the circumferential direction of the spray nozzle body (2), a length (L) of the respective baffle plate (5) in the radial direction of the spray nozzle body (2) being greater than a width (B) of the respective baffle plate (5), the respective baffle plate (5) being curved in the shape of a spoon.

### CROSS-REFERENCE TO RELATED APPLICATION

This application claims priority to German application no. 10 2023 132 072.6 filed on Nov. 17, 2023, which is hereby incorporated by reference in its entirety.

### BACKGROUND

### 1. Field of Invention

The invention relates to a spraying device.

### 2. Background Art

As described in DE 10 2018 133 067 A1, a spray nozzle and a method are known in the art. The spray nozzle comprises a body and a deflector. The body comprises a fluid passage and an outer wall. The outer wall has a plurality of fluid flow openings in fluid communication with the fluid passage, at least partially circumferentially spaced around the outer wall. The deflector is arranged at least partially circumferentially around and radially outside the body in fluid communication with the plurality of fluid flow openings and has slots and fingers that are at least partially circumferentially spaced around the deflector.

The object of the invention is to provide an improved spraying device compared to the prior art.

### SUMMARY

The object is achieved by a spraying device according to the appended set of claims.

Advantageous embodiments of the invention are the subject of the subclaims.

A spraying device according to the invention, in particular for cleaning an interior of a container, for example an interior of a tank, has a hollow cylindrical spray nozzle body which has a connection molding on an upper end face for connection to a fluid supply line and is closed on the opposite lower end face. A cylinder jacket of the spray nozzle body has a plurality of fluid flow openings arranged at the same height and distributed over a circumference of the spray nozzle body. A number of baffle plates corresponding to the number of fluid flow openings are arranged on the spray nozzle body, wherein the baffle plates are distributed around the circumference of the spray nozzle body and exactly one of the baffle plates is assigned to each fluid flow opening. In other words, each fluid flow opening is assigned its own baffle plate and the baffle plates are arranged in such a way that the respective fluid flow opening is precisely and exclusively aligned with the baffle plate assigned to it, so that a spray jet emitted from the respective fluid flow opening strikes only the baffle plate associated with the fluid flow opening and does not strike any of the other baffle plates before striking the baffle plate.

The baffle plates are each arranged on the spray nozzle body so as to project from it in its radial direction, i.e. they are each aligned, at least essentially, in the radial direction of the spray nozzle body.

For example, the respective baffle plate is fixedly connected to the spray nozzle body, in particular in a rotationally fixed manner. In another embodiment, the respective baffle plate is movably connected to the spray nozzle body, in particular such that it can rotate, in particular such that it can rotate about the radial of the spray nozzle body at the point of connection of the respective baffle plate. As a result, the respective baffle plate is rotated by the impact of the spray jet from the fluid flow opening that is assigned to the respective baffle plate, thereby creating a changing spray pattern. For example, it may be provided that all the baffle plates of the spraying device are fixedly connected to the spray nozzle body, in particular in a rotationally fixed manner, or that all the baffle plates of the spraying device are movably connected to the spray nozzle body in the manner described, or that one or more baffle plates are fixedly connected to the spray nozzle body, in particular in a rotationally fixed manner, and that the one or more other baffle plates are movably connected to the spray nozzle body in the manner described.

The baffle plates are spaced apart from one another in the circumferential direction of the spray nozzle body. A length of the respective baffle plate in the radial direction of the spray nozzle body is greater than a width of the respective baffle plate, in particular at least twice the width of the respective baffle plate. The width of the baffle plate is in particular a width direction of a surface of the baffle plate directed upwards or downwards, perpendicular to the length direction of the baffle plate, i.e. in particular aligned in the tangential direction of a tangent of the spray nozzle body at the point of intersection of the radials of the spray nozzle body at the point of connection to the baffle plate.

The respective baffle plate is curved, in particular in the direction of a circumferential edge, in particular spoon-shaped, in particular ladle-shaped, i.e. in the form of a ladle of a cutlery spoon. It is curved in particular in the direction of the fluid flow opening with which it is associated. In particular, the respective baffle plate is curved in the direction of a circumferential section at a free end of the baffle plate facing away from the spray nozzle body in such a way that this circumferential section at this free end facing away from the spray nozzle body is curved in the direction of the fluid flow opening, i.e. a circumferential edge of this circumferential section is at a smaller radial distance from the fluid flow opening than it would be in the non-curved state of the baffle plate. When the respective baffle plate is arranged under its associated fluid flow opening, it is curved upwards, in particular in the direction of the circumferential edge, and in a correspondingly different direction when it is arranged differently in relation to the fluid flow opening. That is to say, when the respective baffle plate is for example arranged above its associated fluid flow opening, it is curved downwards, in particular in the direction of the circumferential edge. In particular, it is envisaged that the respective baffle plate is curved in the manner described, starting from the spray nozzle body in the radial direction up to the circumferential edge, and in the manner described in the widthwise direction, starting from a central area to a respective lateral circumferential edge.

In one possible embodiment, the respective baffle plate is arranged on the spray nozzle body, as already mentioned, in particular under the fluid flow opening to which it is assigned. The upward curvature ensures that a fluid jet sprayed from the fluid flow opening in the radial direction of the spray nozzle body strikes the curved baffle plate and is deflected by it, in particular upwards, in line with its curvature. In the case of a different arrangement of the baffle plate relative to the fluid flow opening, as described above, and a correspondingly different curvature, the fluid jet sprayed from the fluid flow opening in the radial direction of the spray nozzle body also strikes the curved baffle plate and is deflected by it, corresponding to its curvature.

The arrangement of the baffle plates in relation to the associated fluid flow opening, i.e. above, below or, for example, to the side of the fluid flow opening, can be the same for all baffle plates or the baffle plates can be arranged differently.

In one embodiment, a plurality of fingers are formed on a circumference of the respective baffle plate, spaced apart from one another in the circumferential direction of the baffle plate. In particular, the fingers are formed on a circumferential section on a free end of the baffle plate facing away from the spray nozzle body and/or, starting from this free end, at least over a partial section of the respective lateral circumferential section in the direction of the spray nozzle body on the circumference of the respective baffle plate. This design can be provided for one or more or all baffle plates of the spraying device.

The respective baffle plate thus has in particular a plant leaf shape, in particular a deciduous tree leaf shape. The baffle plates can be shaped in the same way or in different ways.

The solution described makes it easy to deflect, fan and distribute the spray jets from the fluid flow openings, particularly upwards and in the circumferential direction of the spray nozzle body. This advantageously achieves a spraying range of 180° for the spraying device, i.e. upwards, in particular as far as the axis, in particular the axis of rotational symmetry, of the spray nozzle body, starting from a circular horizontal plane running through the circumferentially distributed and radially aligned fluid flow openings. This makes it possible to effectively clean the container interior by means of such a simple and inexpensive spraying device, which is not moved in the container interior, but is only arranged in the container interior through a container opening and remains immobile there during spraying. It is particularly important to spray an upper area of the container interior, especially around the container opening, since this area is difficult to clean. Lower areas of the container interior are then also cleaned by the fluid running down an inside of the container space and/or by the fluid collecting in the lower area of the container space.

The connection shape of the spray nozzle body, for example, has a thread for screwing to the fluid supply line or is designed, for example, for a split pin connection to the fluid supply line or for another connection to the fluid supply line.

The described contour, in particular the circumferential contour, of the respective baffle plate is formed, for example, by laser beam cutting, water jet cutting, by machining or in some other way.

The curved shape of the respective baffle plate, as described, is formed, for example, by reshaping in a die. Bending radii are predetermined in particular depending on a cleaning area to be realized and thus depending on a spray pattern required for this and a corresponding jet distribution.

In one embodiment, the fingers each have at least one ramification in the direction of a free end, i.e. the respective finger divides into several branch fingers, at least into two branch fingers. In this case, several or all fingers or, for example, just one of the fingers of the respective baffle plate can each have such ramifications. This can achieve a different spray pattern, for example a finer fanning out of the spray jets emitted from the fluid flow openings. This design can be provided for one or more or all baffle plates of the spraying device. For example, all baffles may have the same or different fannings, or one or more baffles may have the same or different fannings and one or more other baffles may have no fannings.

In one embodiment, the respective baffle plate has holes with a closed hole circumference and/or at least one slot with a closed slot circumference. The slot extends, for example, in the lengthwise or widthwise direction or transversely to the lengthwise and widthwise direction of the baffle plate. In particular, it is spaced apart from the spray nozzle body and from the circumferential section of the free end of the baffle plate facing away from the spray nozzle body. It is formed, for example, in the widthwise direction in the center of the baffle plate. In particular, it is spaced apart from both lateral circumferential sections. Due to the holes and/or the at least one slot it is achieved, for example, that part of the spray jet emitted from the respective fluid flow opening passes through the baffle plate, or more precisely through these holes and/or through this slot in the baffle plate, thereby achieving a modified spray pattern with which further areas of the container interior can be directly sprayed. This design can be provided for one or more or all baffle plates of the spraying device. The slots and/or holes in all baffle plates that have them can be the same or different.

In one embodiment, the respective baffle plate is twisted around a radial of the spray nozzle body. That is to say, the two lateral circumferential sections of the respective baffle plate do in particular not have the same height position with respect to the upper end face of the spray nozzle body, but one lateral circumferential section of the respective baffle plate is positioned higher than the other lateral circumferential section. This twisting of the baffle plates at a predetermined angle is particularly advantageous when the immersion depth in the container interior is low, for example when the spraying device is arranged at a short distance below the container opening. In other embodiments, for example, only one or more, but not all, baffle plates can be twisted in this way.

In one embodiment, the baffle plates are arranged on the circumference of a holding ring. This holding ring is attached to the lower end face of the spray nozzle body.

This allows the baffle plates and their connection to the spray nozzle body to be formed in a particularly simple way. The holding ring is attached to the spray nozzle body, for example, by means of a clamp connection, press fit, plug-in connection, screw connection, welded connection or adhesive connection.

In one embodiment, the cylinder jacket of the spray nozzle body has, spaced apart from the plurality of fluid flow openings in the axial direction of the spray nozzle body, at least a plurality of further fluid flow openings arranged at the same height and distributed over the circumference of the spray nozzle body, wherein a number of further baffle plates corresponding to the number of further fluid flow openings is arranged on the spray nozzle body, wherein the further baffle plates are distributed around the circumference of the spray nozzle body and exactly one of the further baffle plates is associated with each further fluid flow opening, wherein the further baffle plates are spaced apart from one another in the circumferential direction of the spray nozzle body.

In this embodiment, the spraying device thus not only has a single combination of the fluid flow openings and associated baffle plates, which are designed and arranged in the manner described above, but also, axially spaced apart from the latter on the spray nozzle body, i.e. below or above, at least one further combination of the fluid flow openings and associated baffle plates, which are designed and arranged in the manner described above. In particular, they can also be connected to the spray nozzle body in a fixed or movable manner in the manner described above. This is thus a multi-level embodiment of the fluid flow openings and associated baffle plates. There can also be more than two such combinations of fluid flow openings and associated baffle plates, which are arranged on the spray nozzle body in an axially offset manner relative to one another.

The shape and alignment of the baffle plates can be the same in all these combinations or can differ between these combinations. This depends in particular on the spray pattern required for a particular cleaning task. In one possible embodiment, it may also be provided that the baffle plates of at least one of the above-mentioned combinations of fluid flow openings and associated baffle plates are not curved upwards, as described above, but in the opposite direction, i.e. downwards. This respective baffle plate is then arranged in particular above the fluid flow opening associated with it. The spray jet of the fluid flow opening is then deflected downwards by the baffle plate.

In one embodiment, a distance between adjacent baffle plates in the circumferential direction of the spray nozzle body corresponds to a distance between adjacent further baffle plates in the circumferential direction of the spray nozzle body, i.e. the adjacent baffle plates have the same distance to each other in all the above-described combinations.

In one embodiment, the plurality of baffle plates is arranged offset in the circumferential direction of the spray nozzle body relative to the plurality of further baffle plates. This then also applies accordingly to the associated fluid flow openings, i.e. the plurality of fluid flow openings is also arranged in a manner offset in the circumferential direction of the spray nozzle body relative to the plurality of further fluid flow openings. The baffle plates are thus arranged offset in the circumferential direction and in the axial direction of the spray nozzle body relative to the further baffle plates. This particularly avoids the baffle plates hindering each other, i.e. fluid deflected by the respective baffle plate striking another baffle plate, in particular one arranged above it, and being deflected again by it. Likewise, the fluid flow openings are arranged offset in the circumferential direction and in the axial direction of the spray nozzle body with respect to the further fluid flow openings.

The plurality of baffle plates, for example, are arranged in the circumferential direction of the spray nozzle body offset from the plurality of further baffle plates in such a way that one baffle plate is arranged in the circumferential direction of the spray nozzle body between two further baffle plates.

### BRIEF DESCRIPTION OF THE DRAWINGS

Examples of the invention are explained in more detail below on the basis of drawings.

FIG. 1 is a schematic exploded view of an embodiment of a spraying device,

FIG. 2 is a schematic perspective view of the embodiment of the spraying device according to FIG. 1,

FIG. 3 is a schematic view of the embodiment of the spraying device according to FIG. 1 in a plan view from below,

FIG. 4 is a schematic view of the spraying device according to FIG. 1 in a plan view from above,

FIG. 5 is a schematic spray pattern of the spraying device according to FIG. 1,

FIG. 6 is a schematic representation in perspective view of a further embodiment of the spraying device,

FIG. 7 is a schematic representation in a perspective view of a further embodiment of the spraying device,

FIG. 8 is a schematic representation in a perspective view of a further embodiment of the spraying device,

FIG. 9 is a schematic view of the embodiment of the spraying device according to FIG. 8 in a plan view from below,

FIG. 10 is a schematic representation in a perspective view of a further embodiment of the spraying device, and

FIG. 11 is a further schematic representation in a perspective view of the spraying device according to FIG. 10.

Corresponding parts are labeled with the same reference marks in all figures.

### DETAILED DESCRIPTION OF SPECIFIC EMBODIMENTS

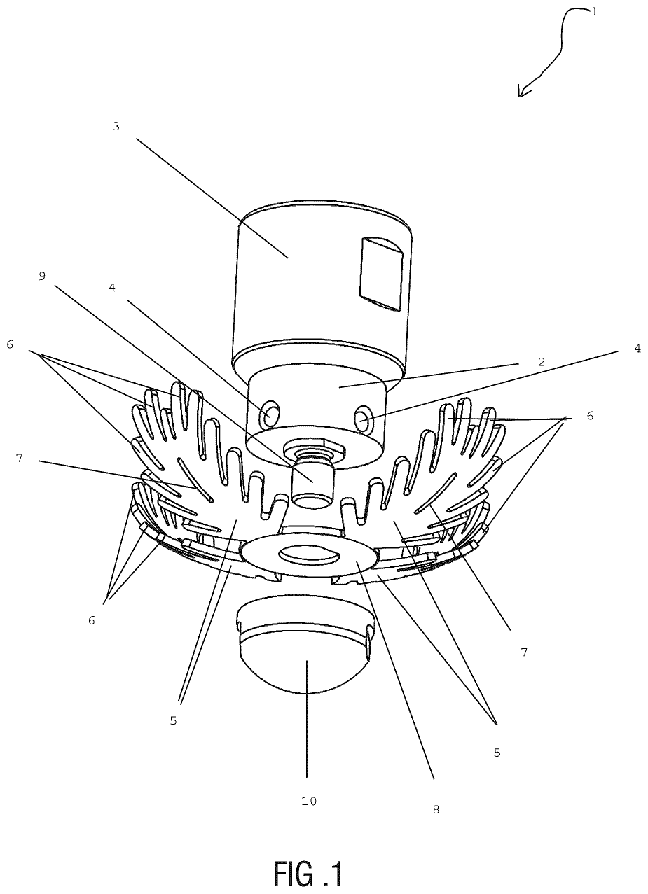

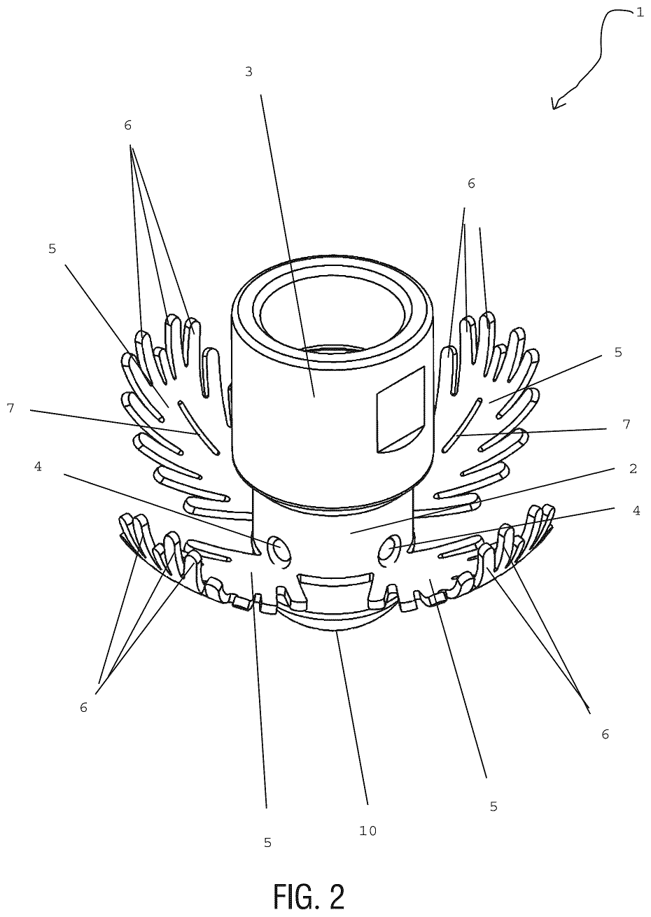

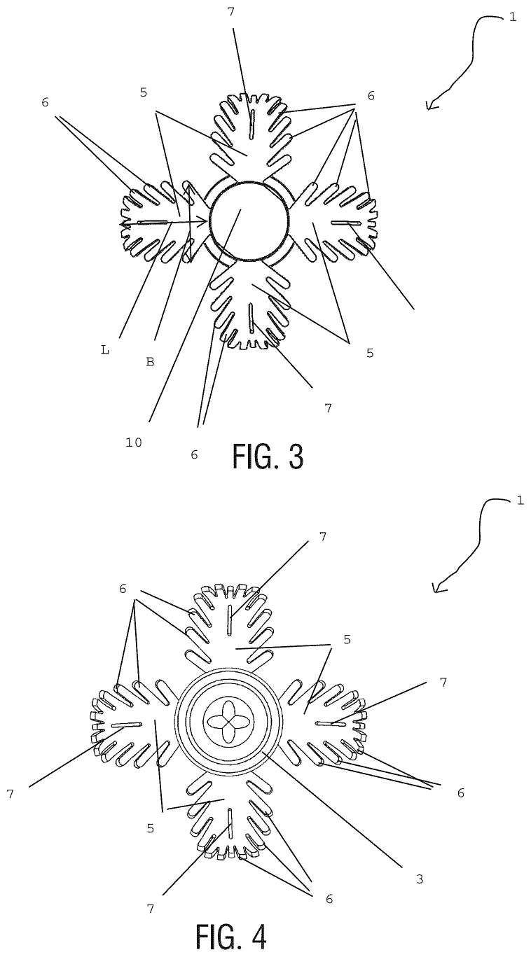

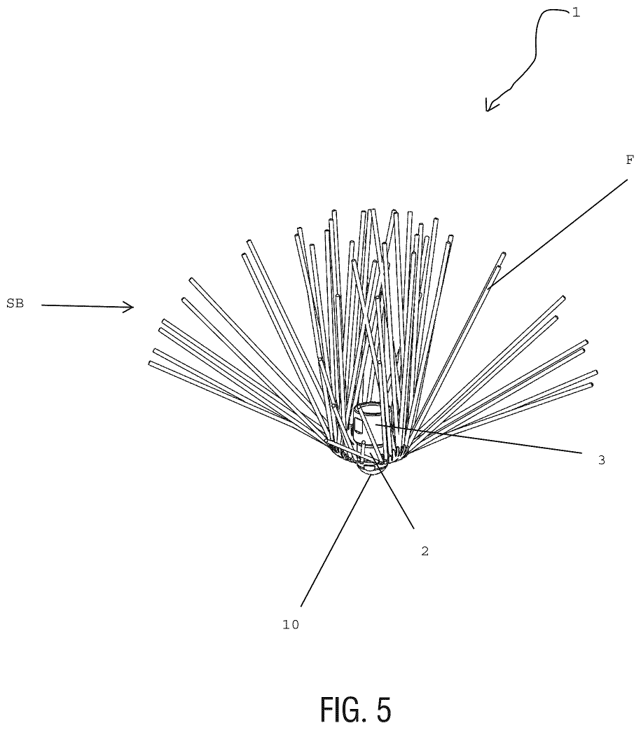

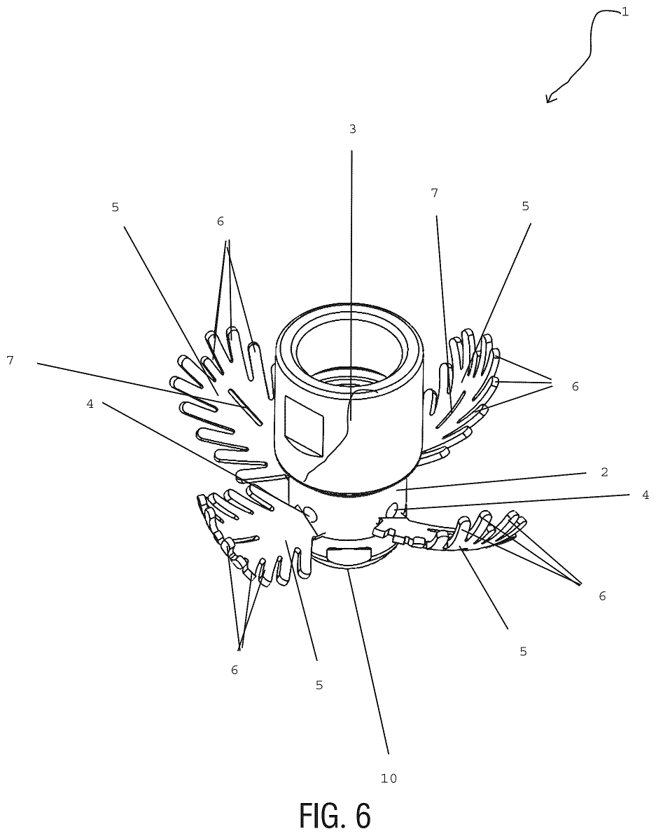

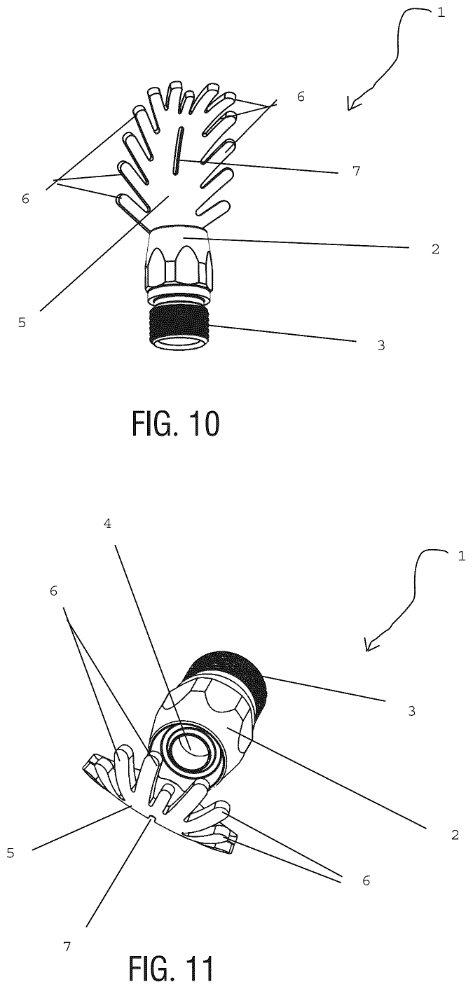

On the basis of FIGS. 1 to 11, exemplary embodiments of a spraying device 1 are described below, which is particularly intended for cleaning an interior of a container, for example an interior of a tank. FIGS. 1 to 5 show a first embodiment of the spraying device 1, with FIG. 5 also showing a spray pattern SB of a fluid F sprayed by the spraying device 1, and FIGS. 6, 7, 8 and 9 as well as 10 and 11 show four further exemplary embodiments, wherein the embodiment according to FIGS. 10 and 11 differs somewhat from the basic design described first below, as will be described later.

In all the embodiments shown, the spraying device 1 has a hollow cylindrical spray nozzle body 2 which has a connection molding 3 on an upper end face for connection to a fluid supply line. The connection molding 3 has, for example, a thread for screwing to the fluid supply line or is designed, for example, for a split pin connection to the fluid supply line or for another connection to the fluid supply line.

In the embodiments according to FIGS. 1 to 9, this spray nozzle body 2 is closed at the opposite lower end face.

In the embodiments according to FIGS. 1 to 7, a cylinder jacket of the spray nozzle body 2 has a plurality of fluid flow openings 4 arranged at the same height and distributed over a circumference of the spray nozzle body 2. In this context, being arranged at the same height means, in particular, that the fluid flow openings 4 are the same distance from the upper end face of the spray nozzle body 2. They are thus arranged in a ring around the spray nozzle body 2.

A number of baffle plates 5 corresponding to the number of fluid flow openings 4 is arranged on the spray nozzle body 2. Just like the fluid flow openings 4, the baffle plates 5 are also distributed around the circumference of the spray nozzle body 2. In this case, exactly one of the baffle plates 5 is assigned to each fluid flow opening 4. In other words, each fluid flow opening 4 is assigned its own baffle plate 5 and the baffle plates 5 are arranged in such a way that the respective fluid flow opening 4 is directed precisely and exclusively at its assigned baffle plate 5, in particular in such a way that a spray jet emitted from the respective fluid flow opening 4 strikes only the baffle plate 5 associated with the fluid flow opening 4 and does not strike any of the other baffle plates 5 before striking the baffle plate 5.

The baffle plates 5 are each arranged on the spray nozzle body 2 so as to project from it in its radial direction, i.e. they are each aligned, at least essentially, in the radial direction of the spray nozzle body 2.

The baffle plates 5 are spaced apart from one another in the circumferential direction of the spray nozzle body 2, i.e. adjacent baffle plates 5 in the circumferential direction of the spray nozzle body 2 do not touch one another. A length L of the respective baffle plate 5 in the radial direction of the spray nozzle body 2 is greater than a width B of the respective baffle plate 5, in particular at least twice the width B of the respective baffle plate 5. The width B of the baffle plate 5 is in particular a width direction of an upwardly or downwardly facing surface of the baffle plate 5. The width B is perpendicular to the length of the baffle plate 5, i.e. in particular in the tangential direction of a tangent of the spray nozzle body 2 at the point of intersection of the radials of the spray nozzle body 2 at the point of connection to the baffle plate 5. FIG. 4 schematically shows the length L and width B using the example of one of the baffle plates 5. In particular, the length L is to be understood as the greatest length L of the baffle plate 5, i.e. the greatest extent in the length direction, and the width B is to be understood as the greatest width B of the baffle plate 5, i.e. the greatest extent in the width direction.

The respective baffle plate 5 is curved, in particular in the direction of a circumferential edge, in particular spoon-shaped, and curved upwards in the illustrated examples. To be more precise, in the illustrated embodiments, the respective baffle plate 5 is curved upwards in the radial direction of the spray nozzle body 2 up to the circumferential edge, and in the width direction, starting from a central region, it is curved upwards to a respective lateral circumferential edge.

The respective baffle plate 5 is arranged under the fluid flow opening 4 to which it is assigned, on the spray nozzle body 2. The upward curvature ensures that a fluid jet sprayed from the fluid flow opening 4 in the radial direction of the spray nozzle body 2 strikes the curved baffle plate 5 and is deflected by it, in particular upwards, as exemplarily shown in FIG. 5. If the baffle plates 5 are arranged differently relative to their associated fluid flow openings 4, the curvature is also aligned differently accordingly. This may be the case, for example, with the further baffle plates 13 and further fluid flow openings 12, which will be described in more detail below. The baffle plates 5 or further baffle plates 13 can, for example, be arranged above the respective fluid flow opening 4 or further fluid flow opening 12 and be designed such that they are curved downwards.

On a circumference of the respective baffle plate 5, in the illustrated examples, a plurality of fingers 6 are formed, which are spaced apart from one another in the circumferential direction of the baffle plate 5. The fingers 6 are formed on a circumferential section at a free end of the baffle plate 5 facing away from the spray nozzle body 2 and, starting from this free end, at least over a partial section of the respective lateral circumferential section in the direction of the spray nozzle body 2 on the circumference of the respective baffle plate 5.

The respective baffle plate 5 thus has in particular a plant leaf shape, in particular a deciduous tree leaf shape. The baffle plates 5 can be shaped in the same way or in different ways.

The described contour, in particular the circumferential contour, of the respective baffle plate 5 is formed, for example, by means of laser beam cutting, water jet cutting, by machining or in some other way.

The curved shape of the respective baffle plate 5 is formed, for example, by reshaping in a die. Bending radii are specified in particular depending on the cleaning area to be realized and thus depending on the spray pattern required for this and a corresponding jet distribution.

In possible embodiments, the respective baffle plate 5 has a slot 7 with a closed slot circumference, as shown for example in FIGS. 1 to 4, 6 and 8 to 11. In the illustrated examples, the slot 7 extends in the longitudinal direction of the baffle plate 5, is spaced apart from the spray nozzle body 2 and from the circumferential section of the free end of the baffle plate 5 facing away from the spray nozzle body 2, and is formed in the center of the baffle plate 5 in the width direction and is spaced apart from both lateral circumferential sections. In other embodiments not shown here, other alignments of the slot 7 are also possible. Alternatively or in addition to this slot 7, the respective baffle plate 5 can, for example, have several holes.

In the exemplary embodiment shown in FIG. 6, the respective baffle plate 5 is aligned twisted about a radial of the spray nozzle body 2. In other words, the two lateral circumferential sections of the respective baffle plate 5 are not, in particular, at the same height with respect to the upper end face of the spray nozzle body 2, but rather one lateral circumferential section of the respective baffle plate 5 is positioned higher than the other lateral circumferential section.

The baffle plates 5 are arranged in particular on the circumference of a holding ring 8, as shown for example in FIG. 1. This holding ring 8 is attached to the lower end face of the spray nozzle body 2. The holding ring 8 is attached to the spray nozzle body 2, for example, by means of a clamping connection.

In the illustrated example, this is done by means of a clamping bolt 9 on the lower end face of the spray nozzle body 2, onto which the holding ring 8, which has a feed-through opening, is being pushed or, in the other examples, is already pushed on, and by means of a clamping element 10, which is shaped here as a cap and which is then being pushed on the clamping bolt 9 or is already pushed on in the other examples. The clamping element 10 is then held on the clamping bolt 9 in a force-locking manner, for example, by clamping the clamping bolt 9 in the clamping element 10, and/or in a form-locking manner, for example, by latching the clamping element 10 with the clamping bolt 9. The holding ring 8, which has the baffle plates 5, is then held on the lower end face of the spray nozzle body 2 by means of the clamping element 10, in particular clamped between the clamping element 10 and the spray nozzle body 2.

In order to prevent the holding ring 8 from twisting in the circumferential direction of the spray nozzle body 2 and thus to prevent a change in the alignment of the baffle plates 5 relative to the fluid flow openings 4, in particular a locking device between the holding ring 8 and the spray nozzle body 2 is provided, for example in the form of corresponding and interlocking locking formations on the spray nozzle body 2 on the one hand and on the holding ring 8 on the other hand.

As an alternative to the clamping connection, the fastening of the holding ring 8 to the spray nozzle body 2 can be carried out, for example, by means of a press fit, plug-in connection, screw connection, welded connection or adhesive connection.

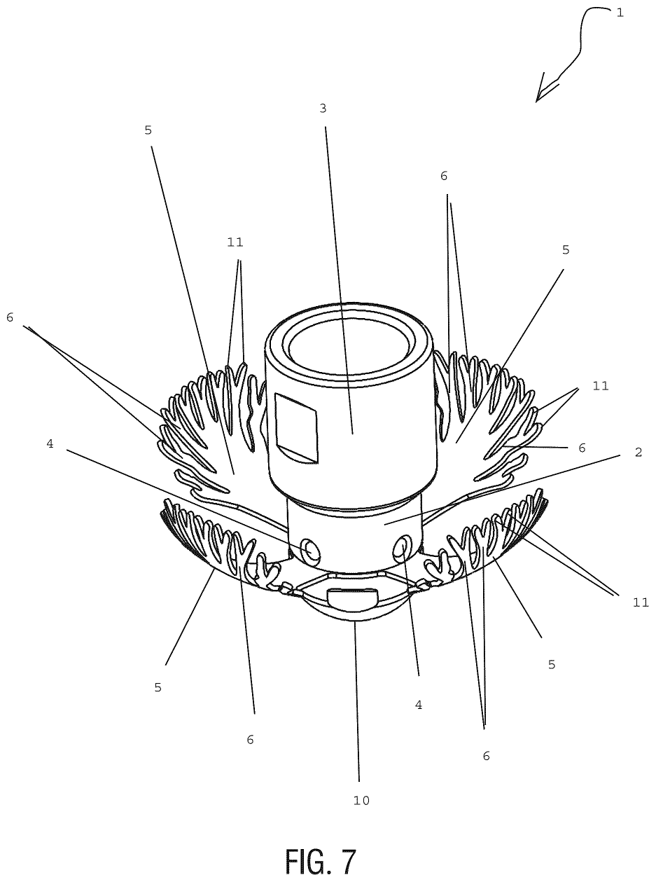

In the embodiment according to FIG. 7, the fingers 6 of the respective baffle plate 5 each have at least one ramification in the direction of a free end, that is to say the respective finger 6 divides into a plurality of branch fingers 11.

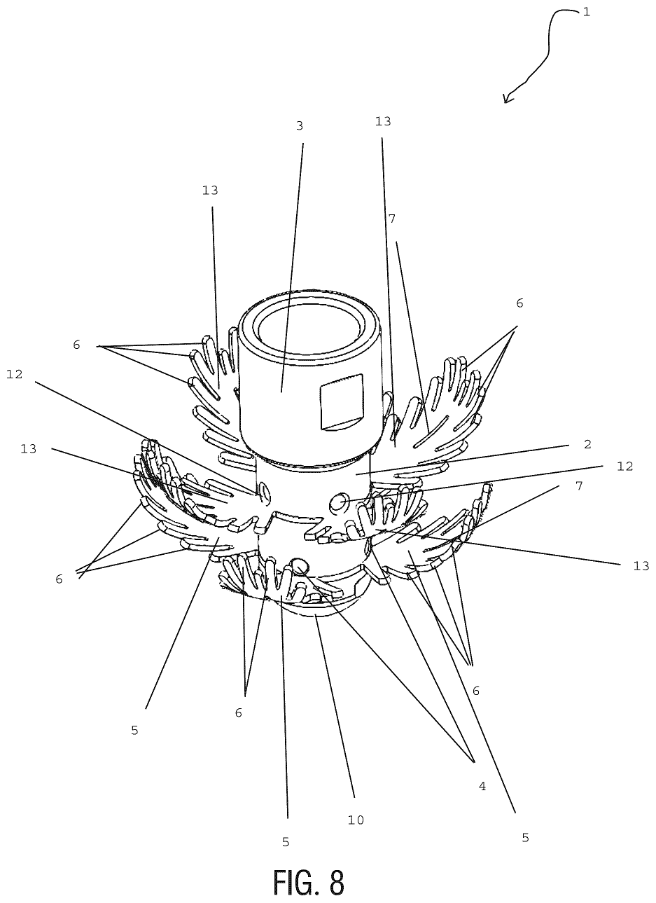

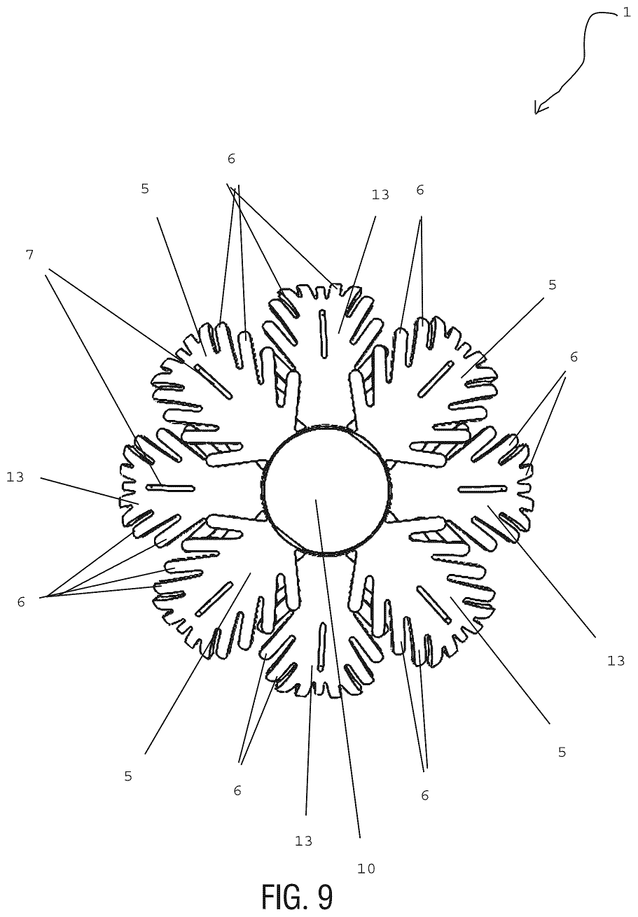

In the embodiment according to FIGS. 8 and 9, the cylinder jacket of the spray nozzle body 2 has, spaced apart in the axial direction of the spray nozzle body 2 from the plurality of fluid flow openings 4, at least one plurality of further fluid flow openings 12 arranged at the same height and distributed over the circumference of the spray nozzle body 2. In this case too, being arranged at the same height means, in particular, that the further fluid flow openings 12 are at the same distance from the upper end face of the spray nozzle body 2. They are thus also arranged in particular in a ring around the spray nozzle body 2. In the illustrated example, the further fluid flow openings 12 are arranged above the fluid flow openings 4, i.e. the fluid flow openings 4 are at a greater distance from the upper end face of the spray nozzle body 2 than the further fluid flow openings 12.

A number of further baffle plates 13 corresponding to the number of further fluid flow openings 12 are arranged on the spray nozzle body 2. These further baffle plates 13 are also distributed around the circumference of the spray nozzle body 2. Here, too, exactly one of the further baffle plates 13 is assigned to each further fluid flow opening 12. In other words, each further fluid flow opening 12 is also assigned its own further baffle plate 13 and the further baffle plates 13 are arranged in such a way that the respective further fluid flow opening 12 is directed precisely and exclusively onto the further baffle plate 13, in particular in such a way that a spray jet emitted from the respective further fluid flow opening 12 strikes only the baffle plate 13 associated with the further fluid flow opening 12.

The other baffle plates 13 are also arranged on the spray nozzle body 2, in particular so as to project from it in its radial direction, i.e. they are each aligned, at least essentially, in the radial direction of the spray nozzle body 2.

The further baffle plates 13 are also spaced apart from one another in the circumferential direction of the spray nozzle body 2, i.e. further baffle plates 13 adjacent to one another in the circumferential direction of the spray nozzle body 2 do not touch one another. The respective further baffle plate 13 is arranged on the spray nozzle body 2 under the further fluid flow opening 12 with which it is associated.

The further baffle plates 13 are in particular designed, in particular shaped, and manufactured and also attached in the same or a similar manner to the spray nozzle body 2, as the baffle plates 5 described above.

In this embodiment, exemplified in FIGS. 8 and 9, the spraying device 1 thus not only has a single combination of the fluid flow openings 4 and associated baffle plates 5, which are designed and arranged in the manner described above, but also, axially spaced therefrom on the spray nozzle body 2, i.e. below or, in the illustrated example, above, at least one further combination of the fluid flow openings 12 and associated baffle plates 13, which are designed and arranged in the manner described above. This is thus a multilevel embodiment of the fluid flow openings 4, 12 and associated baffle plates 5, 13. There may also be more than two such combinations of the fluid flow openings 4, 12 and associated baffle plates 5, 13, which are arranged on the spray nozzle body 2 in an axially offset manner relative to one another. The shape and orientation of the baffle plates 5, 13 can be the same in all these combinations or can differ between these combinations.

In one possible embodiment, it may also be provided that the baffle plates 5, 13 of at least one of the above-mentioned combinations of the fluid flow openings 4, 12 and associated baffle plates 5, 13 are not curved upwards, as described above, but in the opposite direction, i.e. downwards. This respective baffle plate 5, 13 is then arranged in particular above the fluid flow opening 4, 12 assigned to it. The spray jet of the fluid flow opening 4, 12 is then deflected downwards by the baffle plate 5, 13.

In the exemplary embodiment shown in FIGS. 8 and 9, a distance of neighboring baffle plates 5 in the circumferential direction of the spray nozzle body 2 corresponds to a distance of neighboring further baffle plates 13 in the circumferential direction of the spray nozzle body 2, i.e. the adjacent baffle plates 5 are at the same distance from one another as the adjacent further baffle plates 13.

In the exemplary embodiment shown in FIGS. 8 and 9, the plurality of baffle plates 5 in the circumferential direction of the spray nozzle body 2 are arranged offset to the plurality of further baffle plates 13. This then also applies accordingly to the associated fluid flow openings 4, 12, i.e. the plurality of fluid flow openings 4 is also arranged correspondingly offset in the circumferential direction of the spray nozzle body 2 with respect to the plurality of further fluid flow openings 12. The baffle plates 5 are thus arranged offset in the circumferential direction and in the axial direction of the spray nozzle body 2 with respect to the further baffle plates 13. Likewise, the fluid flow openings 4 are arranged offset in the circumferential direction and in the axial direction of the spray nozzle body 2 with respect to the further fluid flow openings 12.

In the exemplary embodiment shown in FIGS. 8 and 9, the plurality of baffle plates 5 are arranged in the circumferential direction of the spray nozzle body 2 offset from the plurality of further baffle plates 13 such that a baffle plate 5 is arranged in the circumferential direction of the spray nozzle body 2 between two further baffle plates 13.

FIGS. 8 and 9 show a simplified embodiment of the spraying device 1. Here, the spray nozzle body 2 has only one fluid flow opening 4 on the lower end face and only one baffle plate 5, which is designed and produced in particular in the manner described above, in particular shaped, and produced like the baffle plates 5. The baffle plate 5 is arranged here on an edge of the lower end face and/or the fluid flow opening 4 and extends downwards in the axial direction of the spray nozzle body 2 and at the same time in the radial direction of the spray nozzle body 2 over the fluid flow opening 4. It is thus curved in these two directions. The baffle plate 5 is thus arranged at a distance from the fluid flow opening 4 in front of the fluid flow opening 4 in the direction of spraying of the fluid flow opening 4. The sprayed fluid is thus deflected laterally and upwards by the baffle plate 5.

### LIST OF REFERENCES

1 spraying device
2 spray nozzle body
3 connection molding
4 fluid flow opening
5 baffle plate
6 finger
7 slot
8 holding ring
9 clamping bolt
10 clamping element
11 branch finger
12 further fluid flow opening
13 further baffle plate
B width
F fluid
L length
SB spray pattern

What is claimed is:

1. A spraying device comprising:
a hollow cylindrical spray nozzle body which has a connection molding on an upper end face for connection to a fluid supply line and is closed on the opposite lower end face,
a cylinder jacket of the spray nozzle body having a plurality of fluid flow openings arranged at the same height and distributed over a circumference of the spray nozzle body,
wherein a number of baffle plates corresponding to the number of fluid flow openings are arranged on the spray nozzle body, the baffle plates being arranged around the circumference of the spray nozzle body and exactly one of the baffle plates being assigned to each fluid flow opening, the baffle plates being spaced apart from one another in the circumferential direction of the spray nozzle body, a length of the respective baffle plate in the radial direction of the spray nozzle body being greater than a width of the respective baffle plate, the respective baffle plate being curved in the shape of a spoon.

2. The spraying device according to claim 1, wherein a plurality of fingers are formed on a circumference of the respective baffle plate, spaced apart from one another in the circumferential direction of the baffle plate.

3. The spraying device according to claim 2, wherein the fingers are formed on a circumferential portion at a free end of the baffle plate facing away from the spray nozzle body and, starting from the free end, at least over a partial portion of the respective lateral circumferential portion in the direction of the spray nozzle body on the circumference of the respective baffle plate.

4. The spraying device according to claim 2, wherein the fingers each have at least one ramification in the direction of a free end.

5. The spraying device according to claim 1, wherein the respective baffle plate has holes with a closed hole circumference and/or at least one slot with a closed slot circumference.

6. The spraying device according to claim 1, wherein the respective baffle plate is twisted around a radial of the spray nozzle body.

7. The spraying device according to claim 1, wherein the baffle plates are arranged on the circumference of a holding ring and wherein the holding ring is attached to the lower end face of the spray nozzle body.

8. The spraying device according to claim 7, wherein the holding ring is attached to the spray nozzle body by means of one of a clamping connection, a press fit, a plug-in connection, a screw connection, a welded connection and an adhesive connection.

9. The spraying device according to claim 1, wherein the cylinder jacket of the spray nozzle body has, at a distance from the plurality of fluid flow openings in the axial direction of the spray nozzle body, at least one plurality of further fluid flow openings arranged at the same height and distributed over the circumference of the spray nozzle body,
wherein a number of further baffle plates corresponding to the number of further fluid flow openings are arranged on the spray nozzle body,
wherein the further baffle plates are distributed around the circumference of the spray nozzle body and precisely one of the further baffle plates is associated with each further fluid flow opening, the further baffle plates being spaced apart from one another in the circumferential direction of the spray nozzle body.

10. The spraying device according to claim 9, wherein a distance of neighboring baffle plates in the circumferential direction of the spray nozzle body corresponds to a distance of neighboring further baffle plates in the circumferential direction of the spray nozzle body.

11. The spraying device according to claim 9, wherein the plurality of baffle plates are arranged offset in the circumferential direction of the spray nozzle body relative to the plurality of further baffle plates.

12. The spraying device according to claim 11, wherein the plurality of baffle plates are offset in the circumferential direction of the spray nozzle body with respect to the further baffle plates in such a way that one baffle plate is arranged between two further baffle plates in the circumferential direction of the spray nozzle body.
